(19) United States
(12) Patent Application Publication
(10) Pub. No.: US 2002/0129107 A1
(43) Pub. Date: Sep. 12, 2002

(54) Method and apparatus for automatic content handling

(76) Inventors: Stephen A. Loughran, Corvallis, OR (US); Weng Wah Loh, Bristol (GB)

Correspondence Address: HEWLETT-PACKARD COMPANY, Intellectual Property Adminsitration, P.O. Box 272400, fort Collins, CO, 80527-2400, US

(21) Appl. No.: 09/804,459

(22) Filed: Mar. 12, 2001

(51) Int. Cl. G06F 15/16

(52) U.S. Cl. 709/206

(57) ABSTRACT

A method and apparatus for performing autonomous data transfer are disclosed. In one preferred embodiment, a mail server notifies a mobile computing device that the server has received new email. Acting in accordance with instructions or an instruction contained within the notification, the mobile computing device connects to the server and downloads the email. The data connection is preferably a wireless connection and the notification is preferably in the form of a SMS message send in accordance with the GSM short messaging service. In an alternative embodiment, the data to be transfer corresponds to a software update or database update. In this embodiment, the mobile computing device downloads the software update and can autonomously execute an install script or the data in the form of a self-extracting archive. In a similar fashion, a remote database can be updated. The remote computing device may be mobile and in the form of a laptop computer incorporating a specially adapted GSM cellular communications module. The invention provides for complete automation of the data transfer process as the specially adapted GSM module can be kept in a passive mode and, on receipt of a notification of pending new email, power up the laptop computer in which it is resident. The invention may find application in the field of mobile computing and remote network administration.

### TECHNICAL FIELD

The present invention relates to methods and apparatus for controlling and handling automatic data content. More particularly, although not exclusively, the present invention relates to methods and apparatus for notifying and handling the transfer of electronic mail, software updates or upgrades and any other forms of data transfer which is initiated independently of a recipient user. The present invention may also find application in maintaining software integrity and currency in relation to, although not restricted to, mobile computer hardware such as notebooks, PDAs, cellular phones and the like.

With modification, the invention may also be used in the area of remote network and/or hardware management in relation to hard-wired or wireless networks of computer hardware or generic network devices, including situations of monitoring, locating and remotely controlling computer hardware.

### BACKGROUND ART

The use of electronic mail (email) is pervasive and, in many situations, essentially taken for granted as a tool for business and personal communication. It's use, however, is somewhat problematic in the context of the mobile or wireless networks. Email sent over a network, using for example SMTP, is ultimately stored in a users INBOX (or logical equivalent). In cases where a user maintains a constant, live connection to the network, a notifying signal is sent to the user interface. This is usually by way of an icon appearing on the users PC desktop or an audible tone when new email arrives. This prompts the user to access the newly arrived email using an email application. This is adequate in situations where the users email interface and application is constantly connected to the mail system via a network connection. However with the rapidly increasing use of small, portable off-line computing platforms such as notebooks and PDA -type devices, mobile users must actively initiate a connection to read their new email. Without doing this, there is no way that the user can know whether there is new incoming email waiting to be downloaded or read. This can be a significant problem. Firstly, a user must in fact remember to check their email on a regular basis. Otherwise, the immediacy of email as a communication medium is lost. Further, depending on the cost of the users network connection, checks for new email initiated on a regular basis can be prohibitively expensive. This is particularly so where the user habitually works with email in offline mode, reading and composing email while disconnected. In this mode, the user only connects to transfer pending outgoing and incoming email.

There are a number of solutions that allow a mobile user to check his or her email. For example, via Ethernet/ISDN or dial-up land line. A popular method of connecting to an ISP when a wired line is not available is via a data enabled cellular phone connected to the users computing device. Once a PPP or similar type of link is established, the mobile device can be used as a client platform to run network applications such as, ftp, email, or HTTP web browsing. With web browsing capability, the user can access web based email system such as such as Hotmail™ instead of POP3. Methods of implementing PPP, POP and HTTP email access are known to the skilled person and will not be discussed in detail.

A number of solutions have been proposed which attempt to address the problems outlined above. Japanese patent application no. JP1997000031139, assigned to Toyo Communication Equipment Ltd, describes a system in which an incoming email causes an email server to send a paging message to an email recipient's pager. The pager indicates that there is a new email by means of an audible tone, vibration or the like. However, the user must still arrange to physically access their email system and thus there is no way to mirror the users normal online email functionality.

WO 99/03239 describes a similar method in which an incoming email causes the server to dial a recipient's telephone. An audible tone or visual indicator notifies the user that he or she has received a new email. Again, the recipient must actively connect to the email server to download or view their email.

In the context of mobile communications, PCT/SE99/02491 describes a system whereby a user is notified of new voicemail messages by means of the Short Message Service available under the GSM standard for cellular communication. However, the technique described is concerned with managing voicemail notification between networks and as such does not address the issue of email notification and access.

None of the references or techniques discussed above address the issue of making mobile email access transparent to the user in such a way that gives the user the impression of shorter or no connection time. It would be extremely useful to provide a mobile email or content system which mirrors that of an always connected online email system.

A number of analogous situations also suffer the same disadvantages as described above. For example, sometimes it is desirable that mobile content be updated non-periodically. An example of such content the installation of periodic software upgrades, periodically updated databases and the like. In the example of a software upgrade, a user usually uses a web browser or an ftp interface to connect to a vendor website. Once the required file is located, it is downloaded to the users local machine using one of the commonly available protocols on the internet. When the file is downloaded on the user machine, an installation script can be run and the appropriate software in the form of configuration files or machine executables can be copied to their required location. Other systems can directly install the upgrade files from the website or ftp site. However, either of these methods suffers the same disadvantages as those described above.

### DISCLOSURE OF THE INVENTION

In one aspect the invention provides for a method of remotely initiating the autonomous transfer of data between a data source and a data destination including the steps of:

in response to a data transfer trigger event, creating a message incorporating information adapted to act as an instruction which initiates the transfer of data;

transmitting to the data destination said message; and

the data destination, acting on the instructions contained in the message, effecting the transfer the data from the data source to the data destination.

Thus, in situations where the data destination is not physically connected to, or in communication with, a data source, the data destination can be controlled so as to connect to the data source and initiate a transfer of the data.

In a first preferred embodiment, the data corresponds to email and the data transfer trigger event corresponds to the receipt of new email, whereupon the email is transferred to the data destination at the instigation of the data destination on receipt of the message.

Preferably the message corresponds to a Short Message System (SMS) transmission sent over a wireless link.

Preferably the data destination corresponds to a computing platform adapted to receive SMS messages.

Preferably the computing platform incorporates a wireless receiver adapted to, on receipt of the SMS message, check for the authenticity and integity of the SMS message, power up if necessary the computing platform and establish a communications link between the main computing platform and the data source to that the email can be downloaded to the computing platform.

The data source may correspond to a mail server, said server adapted to, on receipt of a new email, compile a SMS message containing the necessary instructions to cause the computing platform to establish a connection to the mail server, download the new email and notify the user that a new email has been received.

The connection between the computing platform and the email server may be a wireless communications link.

The computing platform may incorporate a cellular mobile telecommunications circuit adapted to operate when the computing platform is powered up or down and further adapted to be responsive to the SMS message in the manner defined above.

Thus the invention provides a means by which a user of a mobile computing platform can be notified of new email in a manner which is strongly analogous to that exhibited by a live networked connection or email feed. The need for a user to periodically check for the existence of new email by connecting to an ISP or network, is obviated thus saving time, effort and connection costs.

In a second preferred embodiment, the data may correspond to software and the message incorporate instructions which cause the data destination to transfer the software from the data source to the data destination.

The software may correspond to upgrade software, which must be downloaded to the computing platform in order to be installed.

The message may contain instructions which cause the computing platform to connect to the data source, download the upgrade software and install the upgrade.

The instruction may be such that download of the upgrade and installation occurs without any user input at the data destination.

Preferably the transfer of the upgrade software occurs over a wireless link.

In a further aspect the invention provides for a computer or network of computers adapted to carry out the method as hereinbefore defined.

In a further aspect, the invention provides for a mobile computing platform adapted to receive messages from a data source and, on the basis of instruction contained in the message, establish a wireless connection to the data source and download data.

In a further aspect, the invention provides for a computing device for autonomously transferring data from a local computing device to the, said computing device incorporating a wireless communications module adapted to receive an instruction message and, acting on said instructions establish a data connection to the local computing device and transfer the data, said communication module controlling with said computing device.

In yet a further aspect, the invention provides for computer readable media adapted to carry out the method as defined above.

### BRIEF DESCRIPTION OF THE DRAWINGS

The present invention will now be described by way of example only and with reference to the drawings in which:

FIG. 1: illustrates a simplified schematic detailing a mobile computing platform and server architecture;

FIG. 2: illustrates a method of notifying a user of new email; and

FIG. 3: illustrates a method of automatically updating mobile content.

### BEST MODE FOR CARRYING OUT THE INVENTION

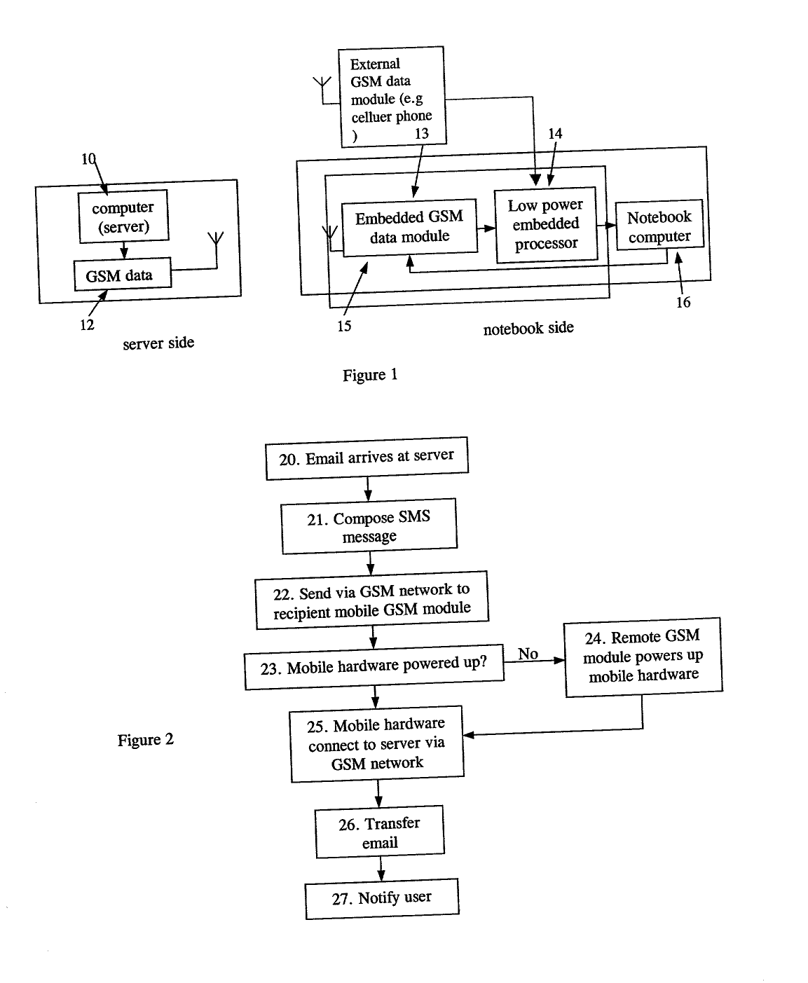

FIG. 1 illustrates a highly simplified example of a system which allows the automatic notification and transfer of data content. By way of exemplary embodiments, the transfer of email and software upgrades will be described. However these are not to be construed as limiting applications. With suitable modification, other types of data could be transferred in different contexts.

Referring to FIG. 1, an email server 10 receives email from a network by means of a network connection (not shown). The mail transfer functionality may be handled by the Simple Mail Transfer Protocol (SMTP) or similar. Software resident on the server identifies the email and its recipient and operates as follows. The server compiles a SMS message which incorporates a digital signature and an “EMAIL”, or similar, header string. Of course it is possible that the instruction message is sent from a different physical location to that where the email is stored (i.e. the email server). There may be some advantage in transmitting the message from a source/location which is not physically associated with the server. The SMS message also includes sufficient information to instruct the recipient mobile hardware to connect to the email server and download the email. This may be in the form of a download script which includes a dial string, and, if necessary, other instructions to control the operation of the mobile hardware. It is also possible that the SMS message may contain only minimal information. For example, it might be simply a flag which causes the remote computer to act on information residing on that device which has been preconfigured.

The SMS message is then sent to the mobile hardware via the GSM network. The server would need to know the telephone number of the mobile hardware's GSM module or phone in order to route the SMS message correctly. It is noted that although the present description is given in the context of mobile cellular phones, those skilled in the art will recognize that the invention can also be applied in where other types of hardware handle the communications and data transfer. Although ideally and preferably suited to mobile applications, the message could be transmitted on wired networks. Of course, this situation would require the remote computing device to be connected at the time that the data transfer is attempted. Also, although the present description refers to the GSM system, the present invention may, with suitable modification, to any communication system in which messages and data can be routed by wireless means.

The mobile hardware will usually be in the form of a mobile computing platform such as a laptop computer. The computer will preferably incorporate a modified GSM data module or similarly functioning circuit. In a preferred embodiment this circuit will consist of a GSM receiver/transmitter and a microprocessor programmed to recognize and act on the unique SMS message sent by the said server. For the purpose of this discussion, this GMS transceiver+microprocessor circuit−can be called the ‘Alert module’. this corresponds to the combination of 14+15 in figure (1). Alternatively, the notebook may communicate with an external GSM module by means of an infrared or wired link. To ensure that the Alert module is able to receive SMS messages at all times, the alert module may include a supplementary power supply which is charged when the laptop is connected to mains power.

To this end, it is usual for laptops and other mobile computing devices to be switched off when not in use. This, however, would not necessarily be a barrier to the operation of the invention. The alert module associated with the mobile device could be maintained in a low power consumption standby mode and on receipt of an SMS message containing an “EMAIL” header, power up the notebook.

Once the laptop is powered up, the alert module would pass the connection and download instructions to the laptop CPU. The laptop would then dial the Internet Service Provider (ISP), connect to the mail-server and download the email. Passing the instructions from the alert module to the laptop hardware could be achieved using a script-file or using purpose-written software. The required functionality occurring between the alert module and the CPU or laptop hardware could be implemented in a number of ways and is considered to be within the scope of one skilled in the art.

Once the pending incoming email is downloaded, the notebook disconnects from the ISP. Depending on the email application software resident on the mobile device, a notification prompt is activated. This might be a visual indicator such as an illuminated light emitting diode or a icon appearing in the system tray or desktop. Alternatively or additionally, new email might be indicated by means of an audible tone. It can be seen that the invention desirably allows for the remote autonomous transfer of data. That is, without any intervention or input from a remote user.

While the invention is primarily concerned with notifying the user of incoming email, the temporary connection initiated by the SMS message provides the opportunity for the mobile hardware to upload any pending outgoing email originating from the mobile user. This particular mode of operation could be selected by the user.

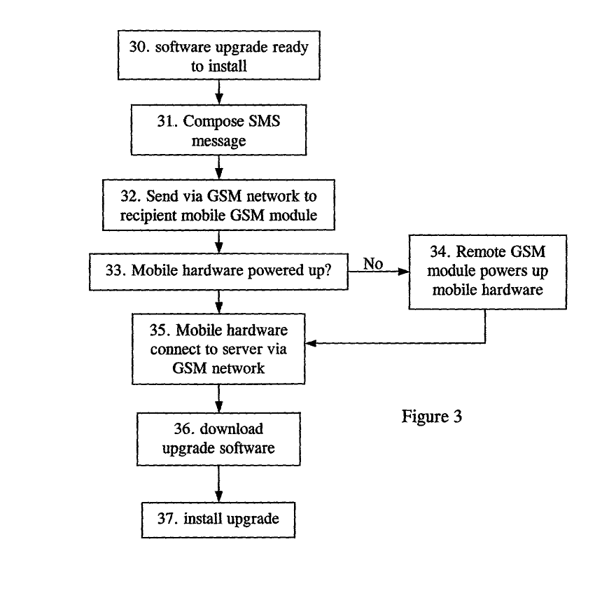

FIG. 3 illustrates a second embodiment. In this case the content corresponds to a software upgrade. Software upgrades may occur periodically. However, major software upgrades are often preceded by a lengthy period of bug-testing and code adjustment/rewriting. Notification of software upgrades can be sent via email. However, in the case of a mobile user, access to an upgrade can be problematic. This problem is exacerbated in situations where the upgrade is eagerly sought and ostensibly fixes major problems with existing software. Usually an upgrade is installed directly from some form of removable media such as floppy disks or CDROMs. However, the target hardware must be in data communication with the upgrade source for this to be possible.

The present invention can solve this problem the following way. The upgrade provider server compiles an SMS message containing instructions, which cause the mobile hardware to connect to the upgrade server and download the upgrade software. As for the email embodiment described above, the message can be sent from a different location to that at which the upgrade software is stored. In fact the three functions of administering the upgrade, transmitting the message and being the source site to which the mobile device connects, can be performed at three different physical or logical locations.

The instructions contained in the SMS message might also contain code which controls the upgrade process itself as well as details of the connection, file location, source server, validation passwords etc. This SMS message is sent to the mobile hardware and, in a similar manner to that outlined above, the alert module checks to see if the mobile hardware is powered up. If necessary, the alert module instructs the CPU to power up the hardware. The SMS message then passes instructions to the mobile hardware in order to establish a connection to the source server (usually by means of a dialup or similar), download the upgrade and install it. The installation step may include the step of invoking an installer or the downloaded software might be an executable, self-installation file. In any case there are a number of techniques by which an upgrade package can be installed once it is resident on the target machine. Such techniques are well known to those skilled in the art and will not be discussed further.

It can be seen that the upgrade process can proceed autonomously, that is, with essentially no interaction or awareness by the user of the mobile hardware. There may be security and virus issues in causing a mobile computing platform to dial a server and download an executable file. However, passwording and authenticating the SMS message in conjunction with properly identifying the target hardware are modifications that may be implemented.

Thus, so long as the mobile software is accessible via chosen communication path (GSM etc), a software upgrade can be performed at the time of the upgrades release. This may be particularly important in a corporate environment where uniformity in operating system and application software may be required. The consequences of out of synchronization releases coexisting in a networked environment can be highly problematic if the day-to-day use of the software requires a substantial degree of interoperability or version compatibility.

In a manner analogous to software upgrades, mirroring operations can be performed in accordance with the invention. This embodiment may be suitable where mobile users need to have installed the most recent version of databases, user or corporate data. For example, if a customer database is updated, a database server or other machine could assemble an SMS message as outlined above, and send it to a recipient PC whereupon the alert module in the PC would dialup the database server and download the updated database. Such a process could, in fact, be scheduled to coincide with times when the mobile user is not using the mobile hardware, such as at night or out of business hours. Therefore, the updated database could be ready for use at the beginning of the working day. Alternatively, the SMS reception, dialup, download and update could all occur in batch mode and the mobile user might not even be aware that his or her mobile hardware has carried out an upgrade or update procedure. The invention may also be useful where an IT manager wishes to locate laptops in the field. An SMS message could be sent to a laptop, following which a signal sent from the device could approximately locate it within a cell.

Thus it can be seen that the present invention provides a substantially improved capability in terms of carrying out administrative tasks, which are usually restricted to a hard-wired or networked piece of computing hardware. It is advantageous in that it can operate without the mobile user being aware and it can be configured to the particular policies or working habits of the corporate or individual.

Although the invention has been described by way of example and with reference to particular embodiments it is to be understood that modification and/or improvements may be made without departing from the scope of the appended claims.

Where in the foregoing description reference has been made to integers or elements having known equivalents, then such equivalents are herein incorporated as if individually set forth.

1. A method of remotely initiating the autonomous transfer of data between a data source and a data destination including the steps of:
in response to a data transfer trigger event, creating a message incorporating information adapted to act as an instruction which initiates the transfer of data;
transmitting to the data destination said message; and
the data destination, acting on the instructions contained in the message, effecting the transfer the data from the data source to the data destination.

2. A method of remotely initiating the autonomous transfer of data as claimed in claim 1 wherein the connection between the data source and the data destination is a wireless communications link.

3. A method of remotely initiating the autonomous transfer of data as claimed in claim 1 wherein the message corresponds to a Short Message Service (SMS) transmission.

4. A method of remotely initiating the autonomous transfer of data as claimed in claim 3 wherein the data destination corresponds to a computing platform adapted to receive and interpret SMS messages.

5. A method of remotely initiating the autonomous transfer of data as claimed in claim 4 wherein the computing platform incorporates a module adapted to, on receipt of an SMS message with appropriate content, power up, if necessary, the computing platform and establish a communications link between the computing platform and the data source so that the data can be downloaded to the computing platform and acted on in a manner specified in the message.

6. A method of remotely initiating the autonomous transfer of data as claimed in claim 5 wherein the module corresponds to a cellular mobile telecommunications circuit adapted to operate when the computing platform is powered up or down and is further adapted to cause the computing platform to establish a connection to the data source, download the data and act on the content in a manner specified in the message.

7. A method of remotely initiating the autonomous transfer of data as claimed in claim 1 wherein the data corresponds to email and the data transfer event corresponds to the data source being in receipt of new email.

8. A method of remotely initiating the autonomous transfer of data as claimed in claim 7 wherein the data source corresponds to a mail server, said mail server adapted to, on receipt of a new email, compile the SMS message containing the instructions so as to cause the computing platform to establish a connection to the mail server, download the new email and initiate a notification event at the computing platform.

9. A method of remotely initiating the autonomous transfer of data as claimed in claim 1 wherein the data may corresponds to software and the message incorporates instructions which cause the data destination to transfer the software from the data source to the data destination.

10. A method of remotely initiating the autonomous transfer of data as claimed in claim 9 wherein the software corresponds to upgrade software which must be downloaded to the computing platform in order to be installed.

11. A method of remotely initiating the autonomous transfer of data as claimed in claim 9 wherein the message contains instructions which cause the computing platform to connect to the data source, download the upgrade software and install the upgrade.

12. A method of remotely initiating the autonomous transfer of data as claimed in claim 11 wherein the instruction may be such that download of the upgrade and installation occurs without any user input at the data destination.

13. A computer or network of computers adapted to carry out the method of claim 1.

14. A mobile computing platform adapted to receive messages from a data source and, on the basis of instruction contained in the message, autonomously establish a wireless connection to the data source and download data.

15. Computer readable media adapted to carry out the method as claimed in claim 1.

16. A remote computing device for autonomously transferring data from a local computing device to the remote computing device, said remote computing device incorporating a wireless communications module adapted to receive an instruction message and, acting on said instructions establish a data connection to the local computing device and transfer the data, said communication module controlling with said remote computing device.

17. A remote computing device as claimed in claim 16, wherein the mobile communications module is adapted to receive messages while the remote computing device is in a powered down state, whereupon the communications module powers up the remote computing device prior to establishing the connection required for data transfer.

18. A remote computing device as claimed in claim 17 wherein the communications module consists of a GSM mobile phone circuit incorporated into the remote computing devices circuitry, wherein the GSM circuit is maintained in a standby state where it can receive wireless, preferably SMS, messages, whereby, on receipt of an appropriate SMS message, the GSM circuit controls the remote computing device in accordance with the instruction(s) contained in the SMS message, including powering up, if necessary, the remote computing device.

19. A remote computing device as claimed in claim 18 wherein the communication link between the local and remote computing devices is established using a GSM communications channel via the GSM circuit.
